(19) United States
(12) Patent Application Publication
(10) Pub. No.: US 2003/0145834 A1
(43) Pub. Date: Aug. 7, 2003

(54) Method and device for storing and/or reading out data of a fuel metering system

(76) Inventors: Rainer Buck, Tamm (DE); Kurt Frank, Schorndorf (DE); Friedrich Boecking, Stuttgart (DE)

Correspondence Address: KENYON & KENYON, ONE BROADWAY, NEW YORK, NY, 10004, US

(21) Appl. No.: 10/204,668

(22) PCT Filed: Jan. 17, 2001
(86) PCT No.: PCT/DE01/00164

(30) Foreign Application Priority Data
Feb. 19, 2000 (DE) 10007691.2

(51) Int. Cl. F02M 51/00

(52) U.S. Cl. 123/480

(57) ABSTRACT

A method and a device for storing and/or reading out data of a fuel metering system, in particular a fuel pump or an injector, are described. Data on the fuel pump and/or the injector is assigned to at least one electronic component. The data is taken into account by a control unit in controlling the fuel metering system. The component is mechanically and/or electrically connected to the control unit during a first interval of time and is mechanically and/or electrically detached from the control unit and/or the fuel metering unit during a second interval of time.

### BACKGROUND INFORMATION

The present invention relates to a method and a device for storing and/or reading out data of a fuel metering system according to the preambles of the independent claims.

A method and a device for storing and/or reading out data of a fuel metering system are known from German Patent 198 51 797, for example. With the procedure described there, an identification feature is assigned to each solenoid valve and/or each injector. This identification feature is detected by a control unit, and the tolerance zone position assigned to the identification feature is corrected through longer or shorter control times. Manufacturing tolerances in the injection quantity of the injector and/or the solenoid valve may be reduced in this way in particular.

Very high demands are made of the identification feature, in particular when using a resistor or a capacitor. Thus, for example, the resistor must have a durable design, i.e., it must retain its value over the entire lifetime of the system.

### ADVANTAGES OF THE PRESENT INVENTION

Due to the fact that the component containing the data is only temporarily connected mechanically and/or electrically to the control unit and/or the fuel metering system, it is possible to use simpler and less expensive components.

It is particularly advantageous if the components are used only once and are functionally and/or physically eliminated after readout of the data. To do so, at least one of the connecting lines between the component and the control unit and/or the fuel metering unit is severed, preferably after the readout. This severing of the line is preferably triggered by automatic severing of a rupture joint in the feeder line due to a longer-lasting current load and/or due to a voltage rise, preferably triggered by the control unit. As an alternative, a manual interruption of at least one feeder line may also be implemented after readout of the resistance value. It is also possible to interrupt both feeder lines by breaking off the resistor.

It is particularly advantageous if the resistor is integrated into a plug. In this case, the plug may be pulled out after input of the values and then reused. It is particularly advantageous to use a plug having two latch positions, so that only the resistor is connected to the control unit in a first latch position, and in the second latch position, the solenoid valve of the injector is connected to the control unit and the resistor is not operative. This offers the advantage that the resistor need not be designed to be durable, and in an emergency the resistor is available for a repeat measurement.

Additional advantageous and expedient embodiments and refinements are characterized in the subclaims.

### DRAWING

The present invention is explained in greater detail below on the basis of the embodiments illustrated in the drawing. FIG. 1 shows the circuit of an output stage for a solenoid valve, and FIG. 2 shows various representations of the device according to the present invention.

FIG. 1 illustrates an embodiment of an output stage for a solenoid valve as an example. This output stage is part of a control unit. This control unit processes various input signals and controls the injectors and/or solenoid valves accordingly as a function thereof. The procedure according to the present invention is not limited to this embodiment. It may also be used with other output stages and other fuel metering units, e.g., those containing piezoactuators.

A load 4 is usually connected at terminals 1 and 2. This load is preferably the coil of the solenoid valve of the injector. The positive terminal of a power supply voltage Ubat is connected to first terminal 1 via a high-side switch HS and a diode. The negative terminal of power supply voltage Ubat is connected to second terminal 2 via a low-side switch LS. In addition, first terminal 1 is connected to a first terminal of a capacitor C via a booster switch BS. The second terminal of capacitor C is also connected to the negative terminal of power supply voltage Ubat.

Furthermore, second terminal 2 is connected to the first terminal of capacitor C via a diode. A diode is connected between booster switch BS and high-side switch HS and first terminal 1, in each case in the direction of flow.

A low-side switch is usually provided for each load. If multiple loads are provided, a high-side switch HS and a booster switch BS are provided for all loads or for a group of loads.

To supply electric current to load 4, high-side switch HS and low-side switch LS are in their switched-through state and allow the current flow to pass through. If the current flow is interrupted, the power stored in load 4 is transferred to capacitor C. At the beginning of the next triggering operation, booster switch BS and low-side switch LS are forcibly tripped. Therefore, load 4 receives an increased voltage in the next triggering operation. Following this booster phase, the high-side switch and the low-side switch are then closed again and the booster switch is opened.

A diode D may be connected in series with the load, the anode of the diode being connected to the load and the cathode being connected to the low-side switch. A classification resistor R is connected in parallel with the series circuit composed of load 4 and diode D. This arrangement of classification resistor R and diode D is advantageous in that in normal operation, diode D has very little effect on the properties of the injector. Through suitable dimensioning of classification resistor R, it is also possible to reduce its influence on load 4. As a rule, the classification resistor has a much larger resistance value than load 4.

Power diode D is cast in the housing together with the coil. At the end of manufacturing, following measurement of the injection quantity, classification resistor R is attached to the load. This is usually done together with the plug formed by two terminals 1 and 2.

In addition, two other switching means A and B as well as a protective resistor RS may also be provided. Switching means B connects second terminal 2 to the first terminal of capacitor C. Switching means A connects the second terminal of the capacitor to first terminal 1 across resistor RS. The switching means are preferably designed as transistors, in particular FET transistors.

A switching means A and a protective resistor RS are needed. If multiple loads are triggered with a common output stage, then one switching means B is required for each load 4. In normal operation, switching means A and B are triggered in such a way that their conductance approaches zero. In other words, they are in their open state. Protective resistor RS is required for compatibility reasons and to protect against faulty triggering.

In one embodiment for determining the classification of the load, the procedure is as follows. At the beginning, capacitor C is charged to a certain level by suitable triggering of the low-side switch and the high-side switch. In a second step, all the switching means, in particular the high-side switch, the low-side switch and the booster switch, are opened. In a third step, switching means A and B of the load to be read out are closed. Capacitor C discharges via classification resistor R and protective resistor RS. In the fourth step, the time required until the voltage on capacitor C has dropped by a defined value is measured. From the time thus established, the resistance value of classification resistor R is then determined. These steps are repeated for each load. It is particularly advantageous if the period of time between dropping below a first threshold and a second threshold for the voltage is measured.

It is advantageous in this procedure that the analysis method is very simple and inexpensive. It is necessary only to compare the voltage on capacitor C with certain reference voltages. It is particularly advantageous that only a few additional components are needed.

The injectors are usually subjected to a final test. After conclusion of the final test, classification resistor R is mounted by plugging it in position, soldering, welding or similar methods. In doing so, the resistors here are selected according to the measured injector class. Three resistance values are preferably selected. In the case of a first resistance value, an additive correction by a positive value is performed; in the case of a second value, an additive correction by a negative value is performed, and in the case of a third value there is no correction.

As an alternative, it is also possible to provide for the resistor to be installed as part of the injector manufacturing process. As part of the final testing or following same, the resistance value is adjusted and the corresponding injector class is selected by appropriate adjustment of the resistance value. This may be accomplished, for example, by laser cutting in the case of a printed resistor or by a similar method.

When the control unit is first turned on, it measures the value of resistor R. This may be accomplished, for example, as described above. As an alternative to this method, other methods of measuring the resistance may also be used. The resistance value is used as a classification feature in the control unit. Therefore, the value of the resistance is preferably stored in a memory device in the control unit. As an alternative, the correction value for the triggering signal may also be stored accordingly.

Before starting operation of the internal combustion engine, i.e., the vehicle, for the first time, at least one feeder line of classification resistor R is interrupted. To do so, it is possible to provide for a special program to run in the control unit before the initial operation of the engine or vehicle, supplying the classification resistor with a very high current and/or a very high voltage value, which leads to automatic severing of a rupture joint, which is similar to what happens with a fuse. As an alternative, it is possible to provide for manual severing of one or both feeder lines after input of the resistance value as part of the manufacturing process. This may be accomplished, for example, by breaking off the resistor, which projects above the surface of the injector. It is particularly advantageous if the resistor is integrated into a plug, which is removed by simply unplugging it.

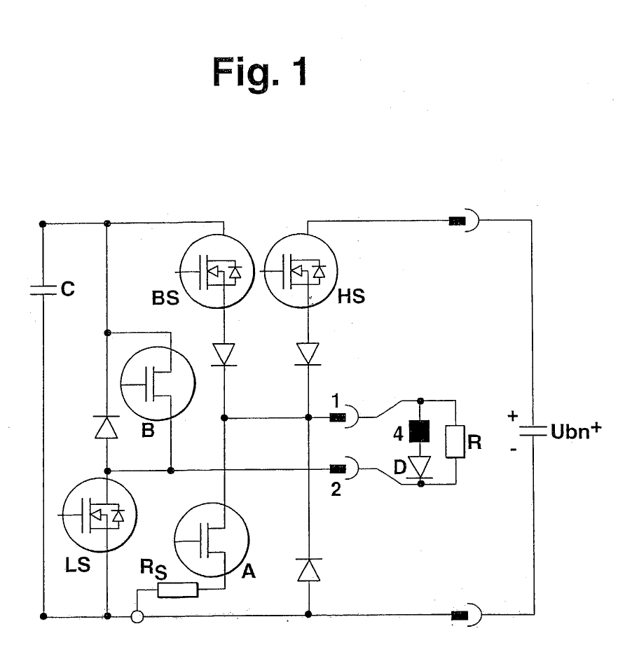

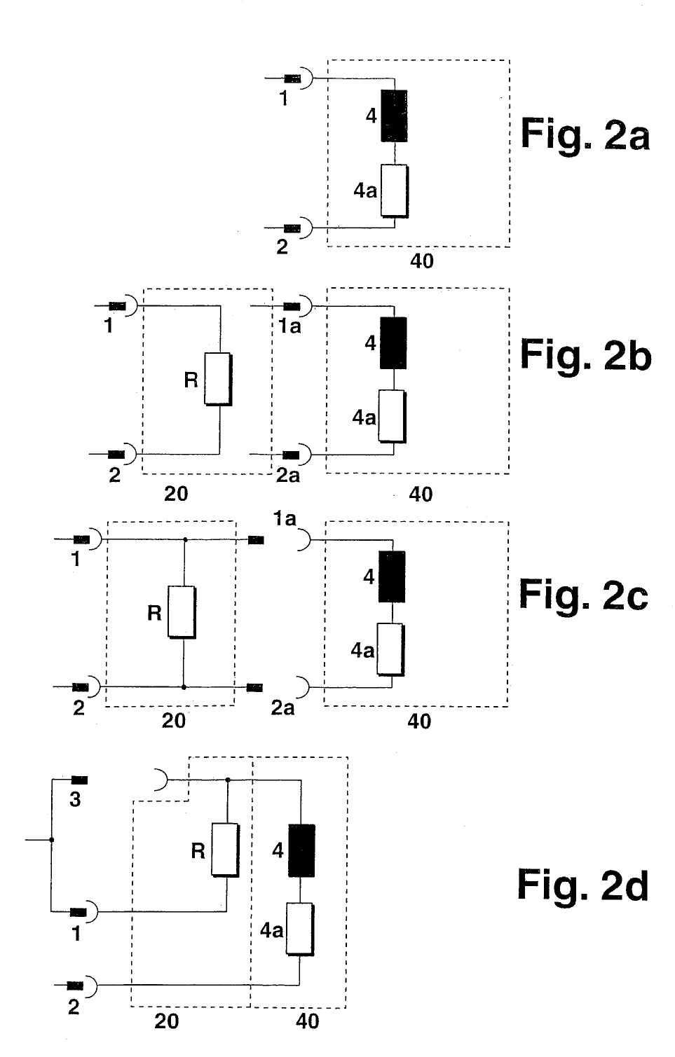

Various embodiments of an implementation having a classification plug are illustrated in FIG. 2. FIG. 2a shows a detail from FIG. 1 on an enlarged scale. Terminals 1 and 2 of the control unit and injector 40 are shown here. The control unit is normally connected to injector 40 by a cable and a plug connector composed of two terminals 1 and 2. Injector 40 usually includes load 4, which is designed as the coil of a solenoid valve, for example. Such solenoid[s] have an ohmic component 4a (not shown in FIG. 1). The diagram in FIG. 2a does not include a classification resistor.

A first implementation is illustrated in FIG. 2b, showing an adapter plug, which is finally removed after readout of the values. In other words, terminals 1 and 2 are connected to one another via classification plug 20. Classification plug 20 contains essentially only resistor R. Testing of the injector determines the class of the injector. According to this classification, a classification plug containing a corresponding classification resistor R is placed on the terminal of the injector but no conducting connection to load 4 is established. The first time the control unit is switched on, there is a classification inquiry in which the value of classification resistor R is read out. Then classification plug 20 is removed and injector 40 is connected to terminals 1 and 2. Depending on the embodiment, it is possible to provide for classification plug 20 to be used again, or it may be stored retrievably in another plug site on the injector without having electrical contact.

It is particularly advantageous in this procedure that no changes in the injector are necessary. Since the adapter plug is removed during operation, it has no effect on the operating performance of the injector. Since the measurement is short, almost any desired resistor or another unambiguously identifiable discrete component may be used for the classification. Thus capacitors or coils may preferably also be used. It is also possible to reuse the adapter plug. It is a disadvantage that no identification is possible after removing the classification plug. As an additional particularly advantageous embodiment, it is also possible to use a more complex, more intelligent semiconductor circuit, which offers more classification options.

In a second embodiment according to FIG. 2c, classification plug 20 has a first and a second latch position. In the first latch position of the classification plug, illustrated in FIG. 2c, terminals 1a and 2a are connected to resistor R, as is also the case in FIG. 2b. Classification resistor R is not electrically connected to injector 40, however. The injector is delivered and installed in the vehicle or internal combustion engine in this position. Classification and readout of the values are performed accordingly, as in the embodiment according to FIG. 2b. In contrast with the embodiment in FIG. 2b, however, classification plug 20 is not removed but instead it is electrically connected to injector 40 in the vehicle, i.e., in the internal combustion engine, by releasing the block and inserting it further into the second latch position. Classification resistor R is thus in parallel with coil 4.

In this embodiment, it is advantageous that classification plug 20 need not be removed, i.e., this eliminates an additional operation. In addition, at a later point in time it is possible to read out the classification again. One disadvantage of this embodiment is the large installation space of the injector in the area of the plug and additional electric contacts. Furthermore, the thermal stability and electric strength must be greater than that according to the embodiment in FIG. 2b, and therefore the value range of classification is slightly restricted.

In the third embodiment according to FIG. 2d, a plug having two latch positions is again used. In the first latch position, illustrated in FIG. 2d, classification resistor R is connected in series with load 4 and it may be read out by the control unit accordingly, as is the case in the other two embodiments. After readout, the plug is transferred to the second latch position, where classification resistor R is short-circuited and thus rendered electrically ineffective.

It is advantageous that no additional classification plug is necessary in this embodiment, because the components are integrated into the plug on the injector. It is a disadvantage that there is a slight increase in complexity in manufacturing the plugs.

What is claimed is:

1. A method of storing and/or reading out data of a fuel metering system, in particular a fuel pump or an injector, data on the fuel pump and/or the injector being assigned to at least one electronic component, the data being taken into account by a control unit in controlling the fuel metering system, wherein the component is mechanically and/or electrically connected to the control unit during a first interval of time and is mechanically and/or electrically detached from the control unit and/or the fuel metering unit during a second interval of time.

2. The method as recited in claim 1, wherein at least one feeder line to the component is severed after the readout.

3. The method as recited in claim 1, wherein the component is removed after the readout.

4. The method as recited in one of claims 1 through 3, wherein the component is integrated into a plug which is removed after the readout.

5. The method as recited in one of the preceding claims, wherein the component is integrated into a plug having at least two latch positions.

6. The method as recited in one of the preceding claims, wherein a first latch position is used for readout of data and a second latch position is used in normal operation.

7. A device for storing and/or reading out data of a fuel metering system, in particular a fuel pump or an injector, data on the fuel pump and/or the injector being assigned to at least one electronic component, the data being taken into account by a control unit in controlling the fuel metering system, wherein the component is mechanically and/or electrically connected to the control unit during a first interval of time and is mechanically and/or electrically detached from the control unit and/or the fuel metering unit during a second interval of time.

8. The device as recited in claim 7, wherein the component is designed as a resistor, a capacitor or an EEPROM.
